(19) United States
(12) Patent Application Publication
(10) Pub. No.: US 2011/0022308 A1
(43) Pub. Date: Jan. 27, 2011

(54) CALCULATING ROUTE AND DISTANCE ON COMPUTERIZED MAP USING TOUCHSCREEN USER INTERFACE

(76) Inventor: Jason A. Britton, Vista, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 12/935,168

(22) PCT Filed: Mar. 31, 2009
(86) PCT No.: PCT/US09/39012

§ 371 Date: Sep. 28, 2010

Related U.S. Application Data
(60) Provisional application No. 61/041,167, filed on Mar. 31, 2008.

(30) Foreign Application Priority Data
Mar. 27, 2009 (US) 12/413482

(51) Int. Cl. G01C 21/34

(52) U.S. Cl. 701/202; 701/209

(57) ABSTRACT

A method and apparatus for computing routes and distances on displayable, computerized maps are disclosed. The apparatus includes a user interface (106) configured to detect a first user touch on a touchscreen (104) indicating a starting point (304) on a map displayed on the touchscreen (104). The user interface (106) also detects a second user touch on the touchscreen (104) tracing an approximate route (306) on the map between the starting point (304) and an end-point (308), and detects a third user touch on the screen indicating the end-point (308). A processor, in cooperation with the user interface, determines and displays on the touchscreen a roadway route (310) between the starting and end-points. The roadway route (310) is based on the approximate route (306) traced on the touchscreen (104). The distance of the roadway route (310) may also be displayed.

### TECHNICAL FIELD

The present invention generally relates to navigational displays, and more particularly, to user interfaces for computerized maps.

### BACKGROUND

It is known to use computerized maps to calculate routes and distances between locations. These maps require users to directly enter data for start and end locations, as well as intermediate stops in between. Known data entry methods for computerized maps are generally text entry boxes and/or pull down menus. These methods require users to know specific or proximate location names, addresses and/or city names, and to enter the information using an alphanumeric data input device, such as a keyboard. After locations have been entered, maps are refreshed, which may then depict an optimal route determined by a computer system. If a user wishes to enter alternative routes between destinations, a new set of individual locations must be entered and identified as intermediary stops between the original start and end locations.

Touchscreen maps that feature tactile user inputs are also known. However, known touchscreen maps have relatively limited functionality. Thus, there is a need for an improved user interface to touchscreen maps.

### SUMMARY

A method and apparatus for computing routes and distances on displayable, computerized maps are described herein. The apparatus includes a user interface configured to detect a first user touch on a touchscreen indicating a starting point on a map displayed on the touchscreen. The user interface also detects a second user touch on the screen tracing an approximate route on the map between the starting point and an end-point, and detects a third user touch on the screen indicating the end-point. A processor, in cooperation with the user interface, determines and displays on the touchscreen a roadway route between the starting and end-points. The roadway route is based on the approximate route traced on the touchscreen. The distance of the roadway route may also be displayed.

Other aspects, features, advantages and variations of the method and user interface will be or will become apparent to one with skill in the art upon examination of the following figures and detailed description. It is intended that all such additional aspects, features, variations and advantages be included within this description and be protected by the accompanying claims.

### BRIEF DESCRIPTION OF THE DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 illustrates an exemplary wireless communication system including a touchscreen wireless communication device capable of displaying a computerized map.

FIG. 2 is a block diagram illustrating certain components of the wireless communication device shown in FIG. 1.

FIG. 3 illustrates the process of tracing and determining a route on a map displayed by a touchscreen.

FIG. 4 illustrates the process of selecting an alternative route on a displayed map.

FIG. 5 is a flowchart illustrating a method of determining and displaying a roadway route on a computerized map.

FIG. 6 is a flowchart illustrating a method of determining a revised roadway route on a computerized map.

### DETAILED DESCRIPTION

The following detailed description, which references to and incorporates the drawings, describes and illustrates one or more specific embodiments of what is claimed. These embodiments, offered not to limit but only to exemplify and teach the invention, are shown and described in sufficient detail to enable those skilled in the art to practice the invention defined by the claims. Thus, where appropriate to avoid obscuring the invention, the description may omit certain information known to those of skill in the art.

The word “exemplary” is used throughout this disclosure to mean “serving as an example, instance, or illustration.” Any embodiment or feature described herein as “exemplary” is not necessarily to be construed as preferred or advantageous over other embodiments or features.

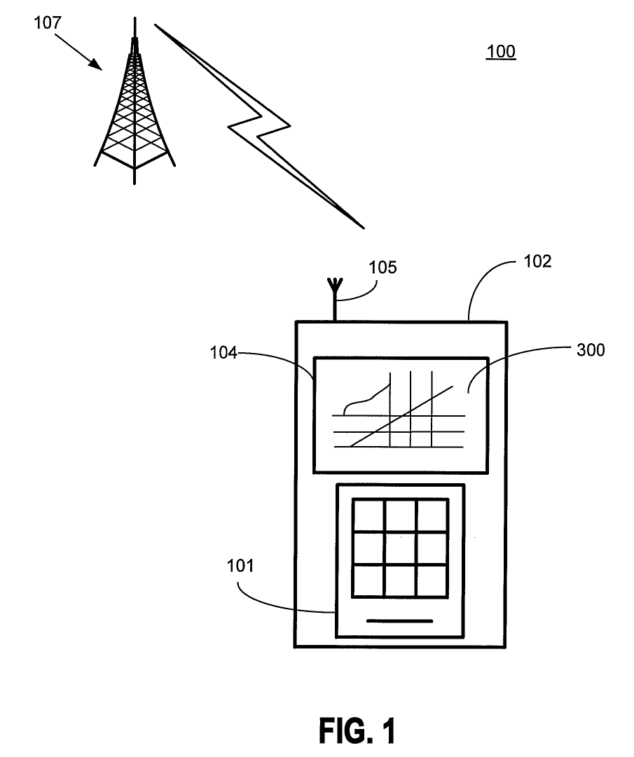

FIG. 1 illustrates an exemplary wireless communication system 100 that includes a touchscreen wireless communication device (WCD) 102 capable of displaying a computerized map 300. Using an antenna 105, the WCD 102 can communicate with one or more base stations 107 by way of one or more wireless links.

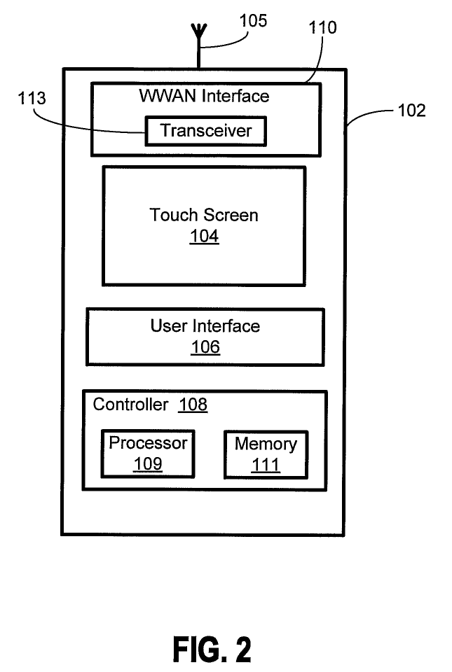

The WCD 102 includes a touchscreen 104 and a user interface 106 (shown in FIG. 2) for monitoring and detecting user inputs on the touchscreen 104. The WCD 102 is configured to compute routes and distances on computerized maps displayed on the touchscreen 104. To accomplish this, the user interface 106 detects user touches to compute and draw a route. Specifically, the user interface 106 is configured to detect a first user touch on the touchscreen 104 indicating a starting point on the map 300 displayed on the touchscreen 104. The first user touch may be an initial tactile contact on the touchscreen 104 by a user's finger, stylus or other suitable means. The user interface 106 also detects a second user touch on the screen tracing an approximate route on the map between the starting point and an end-point, and detects a third user touch on the screen indicating the end-point. The second and any subsequent user touches may be a tactile contact on the touchscreen 104 by a user's finger, stylus or other suitable means. A processor 109 (shown in FIG. 2), in cooperation with the user interface 106, determines and displays on the touchscreen 104 a roadway route between the starting and end-points. The roadway route is based on the approximate route traced on the touchscreen 104. The distance of the roadway route may also be displayed.

The proposed interaction and user interface design allows users to use only a finger touch input to draw a route on the computerized map 300. This configuration is particularly useful for mobile and touchscreen devices that have either limited or no full keyboard available.

The user interface 106 allows users to use a gesture entry action to draw a route on the computerized map 300, and to calculate approximate mileage (distance). The user places his/her finger on the desired starting point, and while maintaining a digit on the touchscreen display 104, moves his/her finger along a desired route depicted on the map 300. When the finger is lifted off of the display 104, the WCD 102 calculates a route and mileage based on the user's gesture input. The WCD 102 generates a viable route that is closest to the route drawn by the user on the touchscreen 104, even if the user's gesture is slightly off from displayed roads.

The WCD 102 is configured so that the user may redraw and recalculate a route by using a gesture to select a portion of a displayed route and to drag it so that it aligns to an alternate route on the computerized map 300. Mileage is then recalculated for the revised route, without the user having to entirely redraw the complete route.

An advantage of the user interface 106 is that it allows users to enter a route without having to know specific coordinates and place names. In addition, it also allows users to create a route based strictly on visual user interface components, rather than having to deal with menus and text entry boxes. A further advantage of the user interface is that it provides for easy modification and customization of an initial route calculation by a convenient gesture action. This significantly improves the usability of computerized maps displayed on the touchscreen 104.

The communication system 100 may be implemented in accordance with any of numerous technologies and communication standards. For example, the system 100 may be a wireless wide-area network (WWAN) operating in accordance with a Code Division Multiple Access (CDMA) standard such as cdma2000 1X. Examples of other suitable communication standards include other CDMA standards such as 1xEV-DO and W-CDMA, UMTS, and GSM standards, and OFDM based standards such as Wi-Max.

The communication system 100 includes system infrastructure (not shown) that is connected to the base station 107. The system infrastructure includes equipment such as controllers, transceivers and backhaul that establishes and maintains wireless communication with the WCD 102, as well as other terminal devices. The types and numbers of devices within the wireless infrastructures depend on the particular wireless network. Communications between the base station 107 and one or more wireless communication devices are at least partially managed by the system infrastructure.

FIG. 2 is a block diagram illustrating certain components of the WCD 102 shown in FIG. 1. The WCD 102 includes the touchscreen 104, user interface 106, controller 108, and WWAN interface 110.

The controller 108 includes a processor 109 and memory 111. The controller 108 controls the overall operation of the WCD 102 and certain components contained therein. The processor 109 can be any suitable processing device for executing programming instructions stored in the memory 111 to cause the WCD 102 to perform its functions and processes as described herein. For example, the processor 109 can be a microprocessor, such as an ARM7, digital signal processor (DSP), one or more application specific integrated circuits (ASICs), field programmable gate arrays (FPGAs), complex programmable logic devices (CPLDs), discrete logic, software, hardware, firmware or any suitable combination thereof.

The processor 109 is interfaced to the user interface 106 and is configured by software stored in the memory 111 to determine the distance between the starting and end-points based on the roadway route. In some embodiments, the processor is configured by software to perform one or more of the functions of the user interface 106 described herein.

The memory 111 is any suitable memory device for storing programming instructions and data executed and used by the processor 109.

Although shown as a stand-alone component, the user interface 106 may include the touchscreen 104 and may be implemented, at least in part, by the controller 108. In some embodiments, the user interface 106 may include its own processor and memory for executing and storing, respectively, software and data for performing the functions of the user interface 106 described herein.

The touchscreen 104 may be any suitable touchscreen, including but not limited to commercially-available touchscreens, capable of performing the functions described herein.

The WWAN interface 110 includes a radio frequency (RF) transceiver 113. The WWAN interface 110 comprises the entire physical interface necessary to communicate with a WWAN (e.g., base station 107). The interface 110 includes the wireless transceiver 113 configured to exchange wireless signals with one or more base stations within a WWAN. The WWAN interface 330 exchanges wireless signals with the WWAN to facilitate voice calls and data transfers over the WWAN to a connected device. The connected device may be another WWAN terminal, a landline telephone, or network service entity such as a voice mail server, Internet server or the like.

The various functions and operations of the blocks described with reference to the WCD 102 may be implemented in any number of devices, circuits, and/or elements as well as with various forms of executable code such as software and firmware. Two or more of the functional blocks of FIG. 2 may be integrated in a single device and the functions described as performed in any single device may be implemented over several devices.

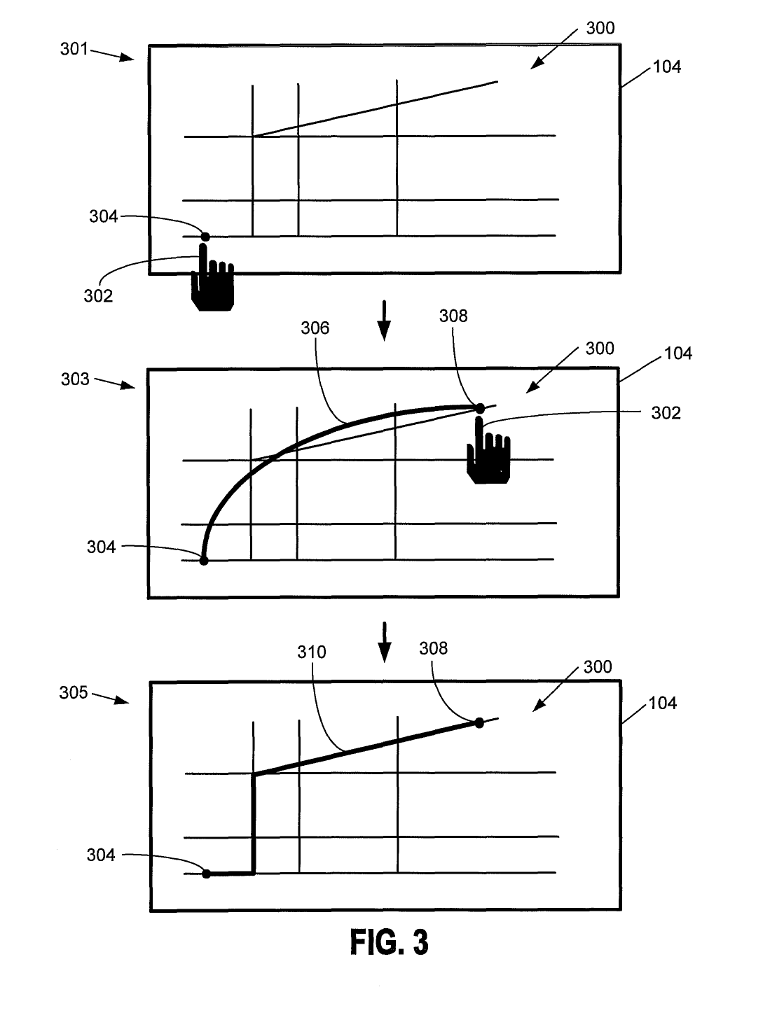

FIG. 3 illustrates the process of tracing and determining a route on a computerized map 300 displayed by the touchscreen 104. In the first block 301, a user selects a starting point on the map 104 by initially touching the touchscreen 104 at a desired starting point 304 with a finger 302, pen or some other suitable stylus. Upon detecting the initial contact on the touchscreen 104, the user interface 106 begins to continuously monitor the touchscreen 104 to detect a route tracing. In the next block 303, the user traces a desired approximate route 306 across the displayed map 300 with his/her finger 302 by moving his/her finger 302 in continuous contact the touchscreen 104. The user interface 106 detects the movement of the finger across the touchscreen 104 and can generate a highlighted line showing the desired route 306 on the map 300. When the user's finger 302 (or stylus) reaches the desired end-point 308, the user lifts his/her finger 302 so that it is no longer in contact with the touchscreen 104. This action indicates the end-point to the user interface 106. The user interface 106 is configured to detect this action by monitoring the touchscreen 104 for a sudden, continued lack of contact after a last contact point. The last contact point so detected is determined to be the end-point 308 selected by the user.

In block 305, the user interface 106 displays an actual roadway route 310 that it has computed based on the user-entered approximate route 306. The displayed roadway route 310 highlights a path on known roads between the starting point 304 and end-point 308. To compute the roadway route 310, the user interface 106 relies on a stored computerized roadway map that has coordinate information regarding roads on the displayed map 300. The user interface 106 does a piecewise comparison between the coordinates of the approximate route drawn by the user and the coordinates of the actual roadways. The actual roads selected by the user interface 106 are the result of minimizing the differences between the coordinates of the actual roads and traced route during the piecewise comparisons.

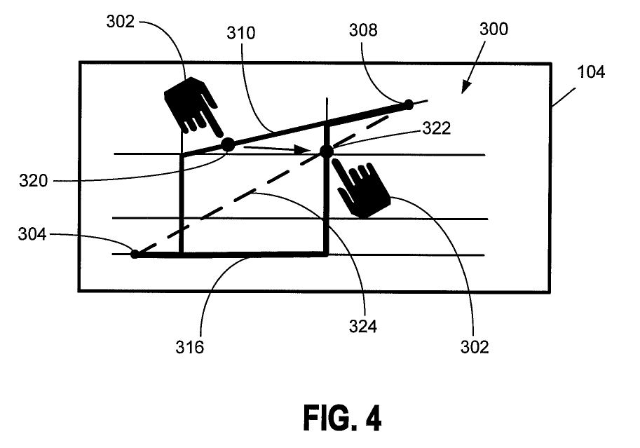

FIG. 4 illustrates the process of selecting an alternative route 316 on the displayed map 300. In this process, the user simply selects a point 320 on a computed, actual roadway route 310 with his/her finger 302 (or stylus) by touching the touchscreen 104, and then drags the point to a new desired location 322. This can be accomplished after the first roadway route 310 is computed by touching the point 320 on the roadway route 310 and then moving the finger 302 over the screen in continuous contact to the new location 322. The user interface 106 can then compute a revised approximate route 324 by computing one or more lines connecting the three selected points 304, 322, 308. Piecewise comparisons between coordinates of the lines of the revised approximate route 324 and coordinates of the actual roads are then minimized to determine the revised actual roadway route 316.

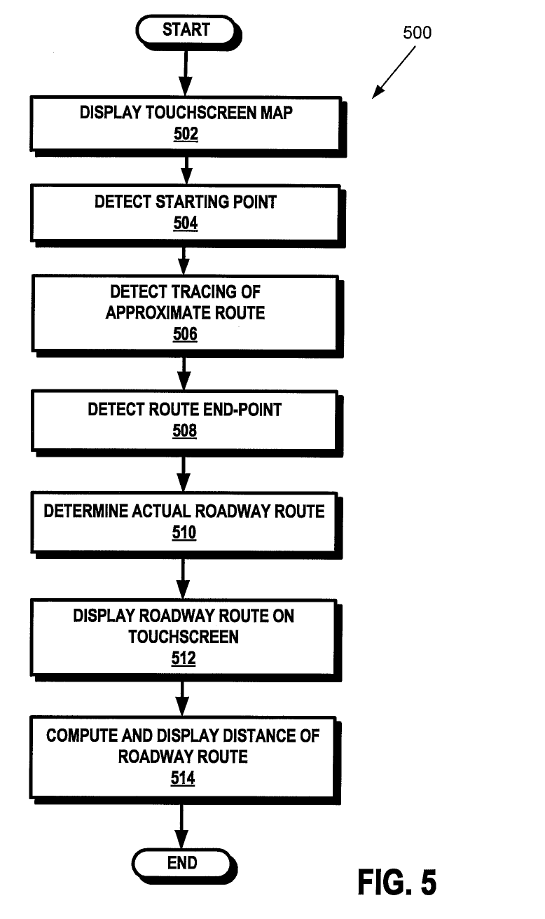

FIG. 5 is a flowchart illustrating a method 500 of determining and displaying a roadway route (e.g., the roadway route 310) on the computerized map 300. In step 502, a map 300 is displayed on a touchscreen. In step 504, a first user touch on the touchscreen is detected, indicating a starting point. In step 506, a second user touch on the touchscreen is detected. The second user touch traces an approximate route on the map between the starting point and an end-point. In step 508, a third user touch is detected on the touchscreen, indicating the end-point. In step 510, an actual roadway route is determined. In step 512, the actual roadway route is displayed on the touchscreen. The actual roadway route is between the starting and end-points and based on the traced, approximate route. In step 514, the distance of the actual roadway route is computed and displayed on the touchscreen.

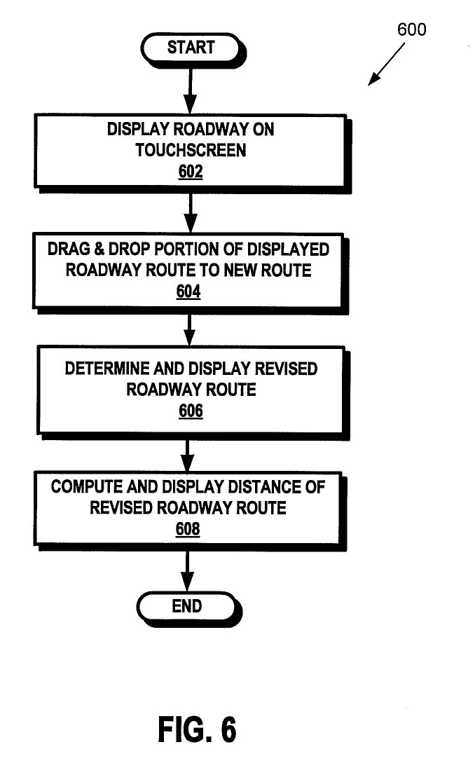

FIG. 6 is a flowchart illustrating a method 600 of determining and displaying a revised roadway route (e.g., the revised roadway route 316) on a computerized map. In step 602, a roadway route is displayed on a touchscreen. In step 604, a drag-and-drop operating is detected on the touchscreen that selects a portion of the roadway route and drags it to an alternative route on the map. In step 606, a revised roadway route between the starting and end-points based on the alternative route is determined and then displayed on the touchscreen. In step 608, the distance is determined between the starting and end-points of revised roadway route, and the distance is then displayed on the touchscreen.

The functionality of the systems, devices, and their respective components, as well as the method steps and blocks described herein may be implemented in hardware, software, firmware, or any suitable combination thereof. The software/firmware may be a program having sets of instructions (e.g., code segments) executable by one or more digital circuits, such as microprocessors, DSPs, embedded controllers, or intellectual property (IP) cores. If implemented in software/firmware, the functions may be stored on or transmitted over as instructions or code on one or more computer-readable media. Computer-readable medium includes both computer storage medium and communication medium, including any medium that facilitates transfer of a computer program from one place to another. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable medium.

Other embodiments and modifications of the methods and apparatuses described above will occur readily to those of ordinary skill in the art in view of these teachings. The above description is illustrative and not restrictive. The invention is to be limited only by the following claims, which cover all such other embodiments and modifications, when viewed in conjunction with the above specification and accompanying drawings. The scope of the invention should, therefore, not be limited to the above description, but instead should be determined with reference to the appended claims along with their full scope of equivalents.

1. An apparatus, comprising:
a user interface configured to:
detect a first user touch on a touchscreen indicating a starting point on a map
displayed on the touchscreen;
detect a second user touch on the screen tracing an approximate route on the map between the starting point and an end-point; and
detect a third user touch on the screen indicating the end-point; and
a processor configured to determine and display on the touchscreen a roadway route between the starting and end-points based on the approximate route traced on the screen.

2. The apparatus of claim 1, wherein the processor is configured to determine the distance between the starting and end-points based on the roadway route.

3. The apparatus of claim 1, wherein the first user touch includes touching the screen with a finger or stylus.

4. The apparatus of claim 1, wherein the second user touch includes moving a finger or stylus across the screen while maintaining contact with the screen.

5. The apparatus of claim 1, wherein the third user touch includes lifting a finger or stylus away from the screen.

6. The apparatus of claim 1, wherein the user interface is configured to detect a fourth user touch on the screen that selects a portion of the roadway route and drags it to an alternative route on the map.

7. The apparatus of claim 6, wherein the processor is configured to determine and display on the screen a revised roadway route between the starting and end-points based on the alternative route.

8. The apparatus of claim 7, wherein the processor is configured to determine the distance between the starting and end-points based on the revised roadway route.

9. The apparatus of claim 1, further comprising the touchscreen.

10. The apparatus of claim 1, included in a wireless communication device.

11. A method of interfacing with a map, comprising:
displaying a map on a touchscreen;
detecting a first user touch on the screen indicating a starting point;
detecting a second user touch on the screen tracing an approximate route on the map between the starting point and an end-point;
detecting a third user touch on the screen indicating the end-point; and
determining and displaying on the touchscreen a roadway route between the starting and end-points based on the approximate route.

12. The method of claim 11, further comprising:
determining the distance between the starting and end-points based on the roadway route.

13. The method of claim 11, wherein the first user touch includes touching the screen with a finger or stylus.

14. The method of claim 11, wherein the second user touch includes moving a finger or stylus across the screen while maintaining contact with the screen.

15. The method of claim 11, wherein the third user touch includes lifting a finger or stylus away from the screen.

16. The method of claim 11, further comprising:
detecting a fourth user touch on the screen that selects a portion of the roadway route and drags it to an alternative route on the map.

17. The method of claim 16, further comprising:
determining and displaying on the screen a revised roadway route between the starting and end-points based on the alternative route.

18. The method of claim 17, further comprising:
determining the distance between the starting and end-points based on the revised roadway route.

19. The method of claim 11, wherein the touchscreen is included in a wireless communication device.

20. The method of claim 11, wherein the map is a computerized map stored in a portable electronic device.
